(19) United States
(12) Patent Application Publication
(10) Pub. No.: US 2023/0232890 A1
(43) Pub. Date: Jul. 27, 2023

(54) METHOD OF APPLYING A COATING TO AN AEROSOL GENERATING ASSEMBLY

(71) Applicant: PHILIP MORRIS PRODUCTS S.A., Neuchatel (CH)

(72) Inventor: Alexis Louvet, Lausanne (CH)

(21) Appl. No.: 17/768,314

(22) PCT Filed: Oct. 7, 2020
(86) PCT No.: PCT/EP2020/078097

§ 371 Date: Apr. 12, 2022

(30) Foreign Application Priority Data
Oct. 14, 2019 (EP) 19203113.6

(51) Int. Cl. A24C 5/60; A24D 1/22; B05B 13/02

(52) U.S. Cl. CPC A24C 5/608; A24D 1/22; B05B 13/0228; B05B 13/0242

(57) ABSTRACT

A method of applying a coating to an aerosol generating assembly (1). The method comprises the steps of: providing an aerosol generating assembly (1) comprising a combustible heat source (2), an aerosol forming substrate (3), and a wrapper (4) joining the combustible heat source (2) and the aerosol forming substrate (3), the combustible heat source (2) having a downstream portion (22) circumscribed by the wrapper, and an upstream portion (21) not circumscribed by the wrapper; and applying, in a first application step, a coating formulation (6) from at least one applicator head (10, 14) onto the upstream portion (21) while rotating the aerosol generating assembly (1) about its longitudinal axis (9).

The present invention relates to a method to provide a coating to a combustible heat source of an aerosol generating assembly and to an apparatus for providing such coating.

Aerosol generating articles in which an aerosol forming substrate, such as a tobacco containing substrate, is heated rather than combusted are known in the art. In one known type of aerosol generating article, an aerosol is generated by the transfer of heat from a combustible heat source to an aerosol forming substrate located downstream of the combustible heat source. During use, volatile compounds are released from the aerosol forming substrate by heat transfer from the combustible heat source and entrained in air drawn through the smoking article. As the released compounds cool, they condense to form an aerosol.

A variety of combustible heat sources for use in heated smoking articles have been proposed in the art. It is known to wrap a coating around the periphery of a combustible heat source of a heated smoking article in order to improve the heat transfer of the heat source and to protect the periphery of the heat source from accidental damage.

In some aerosol generating articles of the prior art, the combustible heat source may be formed integrally with the coating, for example using a die pressing process or a co-extrusion process. However, it would be desirable to provide a method of coating the combustible heat source of an aerosol generating assembly that may enhance the robustness of the aerosol generating assembly which is used to generate an aerosol generating article. It would also be desirable to provide a method of coating the combustible heat source that may allow for selective coating of the combustible heat source without necessarily requiring alignment between the combustible heat source and other components of the aerosol generating assembly.

A method of applying a coating to an aerosol generating assembly is provided. The method may comprise the step of providing an aerosol generating assembly. The aerosol generating assembly may comprise a combustible heat source. The aerosol generating assembly may comprise an aerosol forming substrate. The aerosol generating assembly may comprise a wrapper joining the combustible heat source and the aerosol forming substrate. The combustible heat source may have a downstream portion circumscribed by the wrapper and an upstream portion not circumscribed by the wrapper. The method may comprise the step of applying, in a first application step, a coating formulation from at least one applicator head onto the upstream portion of the combustible heat source while rotating the aerosol generating assembly about its longitudinal axis.

In this disclosure, a method of applying a coating to an aerosol generating assembly is provided, the method comprising steps of:

providing an aerosol generating assembly, the aerosol generating assembly comprising a combustible heat source, an aerosol forming substrate and a wrapper joining the combustible heat source and the aerosol forming substrate, the combustible heat source having a downstream portion circumscribed by the wrapper and an upstream portion not circumscribed by the wrapper; and
applying, in a first application step, a coating formulation from at least one applicator head onto the upstream portion of the combustible heat source while rotating the aerosol generating assembly about its longitudinal axis.

The application of the coating formulation in a first application step may increase the robustness of the aerosol generating assembly. Advantageously, the coating formulation may be applied once parts of the aerosol generating assembly or the complete aerosol generating assembly are assembled. For example, the coating formulation may be applied when at least the heat source has been joined to the aerosol forming substrate by the wrapper. This may reduce the prospect of the layer becoming damaged following the transport and alignment of the heat sources, such as for example the alignment and transport using vibrating bowl feeders. Likewise, applying coating formulation while rotating the aerosol generating assembly about its longitudinal axis ensures a consistent coating without the need for a large number of applicator heads. The application of the coating formulation may advantageously make use of other rotary movements involved in the process of manufacturing of the aerosol generating assembly, such as the rotary movement performed by a tipping machine.

As used herein, “aerosol generating assembly” is used to define an assembly which comprises at least an aerosol forming substrate, a combustible heat source and a wrapper to join the combustible heat source and the aerosol forming substrate. The assembly may be used to generate an aerosol generating article. In an embodiment, the aerosol generating assembly is an aerosol generating article. In an embodiment, the aerosol generating assembly is used to generate at least two subassemblies that in turn may be used to form at least two aerosol generating articles. In an embodiment, the aerosol generating assembly is used to directly generate at least two aerosol generating articles, that is, the aerosol generating assembly is a double stick assembly.

As used herein, the term “aerosol generating article” refers to an article comprising an aerosol forming substrate that is capable of releasing volatile compounds that can form an aerosol.

The aerosol generating assembly may be manufactured with a method comprising the steps of:
aligning the combustible heat source and the aerosol forming substrate,
determining the position of the heat source,
adjusting the positon of the wrapper before it is applied to partially circumscribe the combustible heat source and to circumscribe the aerosol forming substrate.

The position of the combustible heat source may be determined by using an automatized vision system. The position of the wrapper may be adjusted by means of an actuator.

This method may advantageously allow for precise locating of the wrapper on the combustible heat source to ensure that the length of the upstream portion is consistent. This may be important to limit the application of the coating formulation to the upstream portion. This may also enable to make sure that the upstream portion of the combustible heat source has a determined length. Such length may be chosen to enhance the ignition of the combustible heat source.

The actuator may be a paper guiding roller. The angle of the paper guiding roller may be adjusted to change the positon of the wrapper. The angle may be altered by up to 6 degrees with respect to the longitudinal axis of the aerosol generating assembly.

The coating formulation may be used to provide a coating with a thickness of between 50 micrometres and 500 micrometres. Preferably, the resulting thickness may be between 100 micrometres and 200 micrometres. More preferably, the resulting thickness may be 150 micrometres.

The coating formulation may comprise a non-combustible material. The coating formulation may comprise a thermally insulating material. As used herein with reference to the invention, the term “thermally insulating material” is used to describe material having a bulk thermal conductivity of less than about 50 milliwatts per metre Kelvin (mW/(m·K)) at 23° C. and a relative humidity of 50% as measured using the modified transient plane source (MTPS) method.

Preferably, the coating formulation may comprise a thermally insulating material having a bulk thermal diffusivity of less than or equal to about 0.01 square centimetres per second (cm2/s) as measured using the laser flash method.

The coating formulation may comprise ceramic particles.

The use of ceramic particles in the coating formulation may be advantageous since ceramic can be non-combustible and thermally insulating. The use of particles may also advantageously allow the coating formulation to remain porous so that air is able to reach the combustible heat source.

The ceramic particles may have any suitable size. The ceramic particles may have a mean particle size of at least about 0.02 micrometres, or at least about 0.04 micrometres. The ceramic particles may have a mean particle size of no more than about 250 micrometres, no more than about 150 micrometres or no more than about 100 micrometres.

The ceramic particle may have a mean particle size of between about 0.02 micrometres and about 250 micrometres, between about 0.04 micrometres and about 150 micrometres or between about 0.04 and about 100 micrometres.

The ceramic particles may comprise at least one of diatomaceous earth, expanded clay, vermiculite, pearlite, foam glass, kaolinite, and zirconia.

The coating formulation may comprise any amount of ceramic particles. For example, the coating formulation may comprise at least about 60 weight percent of ceramic particles, at least about 70 weight percent of ceramic particles or at least about 80 weight percent of ceramic particles.

The coating formulation may comprise no more than about 95 weight percent of ceramic particles, no more than about 90 weight percent of ceramic particles or no more than about 86 weight percent of ceramic particles.

For example, the coating formulation may comprise between about 60 weight percent and about 95 weight percent of ceramic particles, between about 70 weight percent and about 90 weight percent of ceramic particles or between about 80 weight percent and about 86 weight percent of ceramic particles. The coating formulation may comprise about 85 weight percent of ceramic particles.

Preferably, the ceramic particles comprises diatomaceous earth and kaolinite.

The coating formulation may comprise a rheology modifier.

The provision of a rheology modifier may advantageously control the rheology of the coating formulation to enable the coating formulation to be readily applied to the combustible heat source, for example by dipping or spraying.

As used herein with reference to the invention, the term “rheology modifier” refers to an additive which alters the flow properties of the coating formulation. For example, the rheology modifier may modify the viscosity of the coating formulation. The rheology modifier may increase the viscosity of the coating formulation. The rheology modifier may decrease the viscosity of the coating formulation.

The rheology modifier may be any suitable rheology modifier. The rheology modifier may comprise at least one of cellulose, cellulose derivatives, polyvinyl alcohol, polyethylene imine, polyethylene oxide, polyethylene glycol, xanthan gum, bentonite, microsilica, calcium carbonate, sodium silicate and potassium silicates.

These rheology modifiers may advantageously be particularly effective at providing appropriate rheology properties for the coating formulation.

The coating formulation may comprise any suitable amount of rheology modifier. For example, the coating formulation may comprise at least about 3 weight percent of rheology modifier, at least about 5 weight percent of rheology modifier or at least about 10 weight percent of rheology modifier.

The coating formulation may comprise no more than about 30 weight percent of rheology modifier, no more than about 25 weight percent of rheology modifier or no more than about 20 weight percent of rheology modifier.

For example, the coating formulation may comprise between about 3 weight percent and about 30 weight percent of rheology modifier, between about 5 weight percent and about 25 weight percent of rheology modifier or between about 10 weight percent and about 20 weight percent of rheology modifier. The coating formulation may comprise about 15 weight percent of rheology modifier.

In certain preferred embodiments, the coating formulation may comprise diatomaceous earth, kaolinite, and sodium silicate. In this embodiment, the ceramic particles may comprise diatomaceous earth particles and kaolinite particles. The rheology modifier may be sodium silicate.

The coating formulation may comprise between about 50 weight percent and 70 weight percent of diatomaceous earth, between about 20 weight percent and about 30 weight percent of kaolinite and between about 10 weight percent and about 20 weight percent of sodium silicate. For example, the coating formulation may comprise about 62 weight percent of diatomaceous earth, about 23 weight percent of kaolinite and about 15 weight percent of sodium silicate.

The coating formulation may comprise diatomaceous earth, clay minca and sodium silicate. In this embodiment, the ceramic particles may comprise diatomaceous earth particles and clay minca particles. The rheology modifier may be sodium silicate.

The coating formulation may comprise between about 50 weight percent and 60 weight percent of diatomaceous earth, between about 15 weight percent and about 25 weight percent of clay minca and between about 20 weight percent and about 30 weight percent of sodium silicate. For example, the coating formulation may comprise about 55 weight percent of diatomaceous earth, about 21 weight percent of clay minca and about 24 weight percent of sodium silicate.

The coating formulation may comprise a dispersion aid.

The dispersion aid may comprise at least one of water, polycarboxy ethers, citric acid, polycarboxylate (such as ViscoCrete), melamine sulfonate, naphthalene sulfonate and lignin sulfonate.

The provision of a dispersion aid may advantageously prevent the ceramic particles from agglomerating, providing a homogenous suspension. This may advantageously lead to a homogenous coating formulation.

An example coating formulation may comprise between about 15 weight percent and 25 weight percent of diatomaceous earth, between about 3 weight percent and about 10 weight of percent kaolinite, between about 5 weight percent and about 15 weight percent of sodium silicate and between about 60 weight percent and about 70 weight percent of water. For example, the coating formulation may comprise about 18 weight percent of diatomaceous earth, about 7 weight percent of kaolinite, about 12 weight percent of sodium silicate and about 63 percent of water.

The wrapper may be any suitable wrapper. The wrapper may be a heat-conducting, non-combustible wrapper.

The provision of a heat-conducting, non-combustible wrapper may advantageously allow heat generated during combustion of the heat source to be transferred by conduction to the aerosol forming substrate downstream of the combustible heat source through the heat-conducting, non-combustible wrapper. This may advantageously help to achieve sufficiently high conductive heat transfer from the combustible heat source to the aerosol forming substrate to produce an acceptable aerosol.

Suitable heat-conducting, non-combustible wrappers include, but are not limited to: metal foil wrappers such as, for example, aluminium foil wrappers, steel foil wrappers, iron foil wrappers and copper foil wrappers; metal alloy foil wrappers; graphite foil wrappers; and certain ceramic fibre wrappers.

The wrapper may have any suitable thickness. The wrapper may have a thickness of between about 30 micrometres and about 200 micrometres. The wrapper may have a thickness of at least about 30 micrometres, at least about 50 micrometres or at least about 75 micrometres.

The wrapper may have a thickness of no more than about 250 micrometres, no more than about 200 micrometres or no more than bout 150 micrometres.

For example, the wrapper may have a thickness of between about 50 micrometres and about 500 micrometres. This may advantageously allow the wrapper to have a similar thickness to the coating formed by the coating formulation, allowing the wrapper to be flush with the formed coating.

The combustible heat source may be substantially cylindrical in shape, comprising a longitudinal outer surface which extends longitudinally between a front face and a rear face. When the combustible heat source is substantially cylindrical, the downstream portion and the upstream portion of the combustible heat source are sections of the longitudinal outer face, that is, the downstream portion and the upstream portion do not include the front face and the rear face.

The combustible heat source may be a solid heat source, and may comprise any suitable combustible fuel including, but not limited to: carbon and carbon-based materials containing aluminium, magnesium, one or more carbides, one or more nitrides and combinations thereof. Solid combustible heat sources may be carbon-based, that is, they may comprise carbon as a primary combustible material.

The combustible heat source may be a combustible carbonaceous heat source.

The combustible heat source may be a blind combustible heat source.

As used herein, the term “blind” describes a heat source that does not comprise any airflow channels extending from the front face to the rear face of the combustible heat source.

As used herein, the term “blind” is also used to describe a combustible heat source including one or more channels extending from the front face to the rear face, wherein a substantially air impermeable barrier is provided between the rear face and the aerosol forming substrate. Hence, the one or more channels form one or more closed air passageways in the combustible heat source. In this embodiment, the inclusion of one or more closed air passageways may increase the surface area of the blind combustible heat source that is exposed to oxygen from the air and may advantageously facilitate ignition and sustained combustion of the blind combustible heat source.

Aerosol generating assemblies and aerosol generating articles comprising blind combustible heat sources may comprise one or more air inlets downstream of the rear face of the combustible heat source for drawing air into one or more airflow pathways through the aerosol generating article. Aerosol generating assemblies and aerosol generating articles comprising non-blind combustible heat sources may also comprise one or more air inlets downstream of the rear face of the combustible heat source for drawing air into one or more airflow pathways through the aerosol generating article.

In use, air drawn along the one or more airflow pathways of aerosol generating articles according to the invention comprising a blind combustible heat source does not pass through the blind combustible heat source. The lack of any airflow channels through the blind combustible heat source may advantageously substantially prevent or inhibit activation of combustion of the blind combustible heat source during use. This may substantially prevent or inhibit spikes in the temperature of the aerosol forming substrate during use. By preventing or inhibiting activation of combustion of the blind combustible heat source, and so preventing or inhibiting excess temperature increases in the aerosol forming substrate, combustion or pyrolysis of the aerosol forming substrate under intense puffing regimes may be advantageously avoided. In addition, the impact of a puffing regime on the composition of the mainstream aerosol may be advantageously minimised or reduced.

The inclusion of a blind combustible heat source may also advantageously substantially prevent or inhibit combustion and decomposition products and other materials formed during ignition and combustion of the blind combustible heat source from entering air drawn through aerosol generating articles according to the invention during use thereof. This may be particularly advantageous where the blind combustible heat source comprises one or more additives to aid ignition or combustion of the blind combustible heat source.

In aerosol generating articles according to the invention comprising a blind combustible heat source, heat transfer from the blind combustible heat source to the aerosol forming substrate occurs primarily by conduction. Heating of the aerosol forming substrate by forced convection is minimised or reduced. This may advantageously help to minimise or reduce the impact of a puffing regime on the composition of the mainstream aerosol of articles according to the invention.

In certain embodiments of the invention, the combustible heat source may comprise at least one longitudinal airflow channel, which provides one or more airflow pathways through the heat source. The term “airflow channel” is used herein to describe a channel extending along the length of the heat source through which air may be drawn through the aerosol generating article. Such heat sources including one or more longitudinal airflow channels are referred to herein as “non-blind” heat sources.

Preferably, the combustible heat source may have a length of between about 5 millimetres and about 20 millimetres, more preferably of between about 7 millimetres and about 15 millimetres, most preferably of between about 7 millimetres and about 13 millimetres. In some embodiments, the combustible heat source may have a length of about 9 millimetres.

The upstream portion of the combustible heat source, which is not circumscribed by the wrapper, may preferably have a length of between about 2 millimetres and about 13 millimetres, even more preferably about 6 millimetres.

The downstream portion of the combustible heat source, which is circumscribed by the wrapper, may preferably have a length of between about 2 millimetres and about 4 millimetres, even more preferably between about 2.5 millimetres and about 3.6 millimetres.

Preferably, the combustible heat source may have a diameter of between about 5 millimetres and about 9 millimetres, more preferably of between about 7 millimetres and about 8 millimetres.

As used herein with reference to the invention, the term “aerosol forming substrate” is used to describe a substrate capable of releasing upon heating volatile compounds, which can form an aerosol. The aerosols generated from aerosol forming substrates of aerosol generating articles according to the invention may be visible or invisible and may include vapours (for example, fine particles of substances, which are in a gaseous state, that are ordinarily liquid or solid at room temperature) as well as gases and liquid droplets of condensed vapours.

The aerosol forming substrate may be a solid aerosol forming substrate. Alternatively, the aerosol forming substrate may comprise both solid and liquid components. The aerosol forming substrate may comprise a tobacco-containing material containing volatile tobacco flavour compounds, which are released from the substrate upon heating. Alternatively, the aerosol forming substrate may comprise a non-tobacco material. The aerosol forming substrate may further comprise one or more aerosol formers. Examples of suitable aerosol formers include, but are not limited to, glycerine and propylene glycol.

The aerosol forming substrate may be a rod comprising a tobacco-containing material.

If the aerosol forming substrate is a solid aerosol forming substrate, the solid aerosol forming substrate may comprise, for example, one or more of: powder, granules, pellets, shreds, spaghetti strands, strips or sheets containing one or more of: herb leaf, tobacco leaf, fragments of tobacco ribs, reconstituted tobacco, homogenised tobacco, extruded tobacco and expanded tobacco. The solid aerosol forming substrate may be in loose form, or may be provided in a suitable container or cartridge. For example, the aerosol forming material of the solid aerosol forming substrate may be contained within a paper or other wrapper and have the form of a plug. Where an aerosol forming substrate is in the form of a plug, the entire plug including any wrapper is considered to be the aerosol forming substrate.

The solid aerosol forming substrate may contain additional tobacco or nontobacco volatile flavour compounds, to be released upon heating of the solid aerosol forming substrate. The solid aerosol forming substrate may also contain capsules that, for example, include the additional tobacco or non-tobacco volatile flavour compounds and such capsules may melt during heating of the solid aerosol forming substrate.

The solid aerosol forming substrate may be provided on or embedded in a thermally stable carrier. The carrier may take the form of powder, granules, pellets, shreds, spaghetti strands, strips or sheets. The solid aerosol forming substrate may be deposited on the surface of the carrier in the form of, for example, a sheet, foam, gel or slurry. The solid aerosol forming substrate may be deposited on the entire surface of the carrier, or alternatively, may be deposited in a pattern in order to provide a non-uniform flavour delivery during use.

The aerosol forming substrate may be in the form of a plug or segment comprising a material capable of emitting volatile compounds in response to heating circumscribed by a paper or other wrapper. Where an aerosol forming substrate is in the form of such a plug or segment, the entire plug or segment including any wrapper is considered to be the aerosol forming substrate.

The aerosol forming substrate may preferably have a length of between about 5 millimetres and about 20 millimetres. In certain embodiments, the aerosol forming substrate may have a length of between about 6 millimetres and about 15 millimetres or a length of between about 7 millimetres and about 12 millimetres.

The aerosol forming substrate may comprise a plug of tobacco-based material wrapped in a plug wrap. In preferred embodiments, the aerosol forming substrate comprises a plug of homogenised tobacco-based material wrapped in a plug wrap.

As used herein with reference to the invention, the terms “longitudinal” and “axial” are used to describe the direction between the opposed upstream and downstream ends of the aerosol generating assembly or article, or of a component of the aerosol generating assembly or article. The “longitudinal outer surface” is therefore the outer surface of a component of the aerosol generating assembly article which extends between opposed upstream and downstream ends of the component of the aerosol generating assembly or article.

As used herein with reference to the invention, the terms “abutting” and “abut” are used to describe a component, or a portion of a component, being in direct contact with another component, or portion of a component.

As used herein with reference to the invention, the terms “circumscribe” and “circumscribing” refer to a first feature extending around the entire circumference of a second feature. For example, in the present invention the wrapper circumscribes the downstream portion of the combustible heat source. This means that, along the longitudinal length of the downstream portion of the combustible heat source, the wrapper extends around the entire circumference of the combustible heat source.

As used herein with reference to the invention, the terms “upstream” and “front”, and “downstream” and “rear”, are used to describe the relative positions of components, or portions of components (such as the aerosol forming substrate, the combustible heat source or the wrapper), of the aerosol generating assembly or aerosol generating article in relation to the direction in which air flows through the aerosol generating article generated from the aerosol generated assembly. The aerosol generating article comprises a proximal end through which, in use, an aerosol exits the article for delivery to a user. The proximal end of the aerosol generating article may also be referred to as the mouth end or the downstream end. In use, a user draws on the mouth end of the aerosol generating article. The mouth end is downstream of the distal end. The combustible heat source is located at or proximate to the distal end. The distal end of the aerosol generating article may also be referred to as the upstream end. Components, or portions of components, of the aerosol generating assembly or aerosol generating article may be described as being upstream or downstream of one another based on their relative positions between the proximal end and the distal end of the aerosol generating assembly or article. The front of a component, or portion of a component, of the aerosol generating assembly or article is the portion at the end closest to the upstream end of the aerosol generating assembly or article. The rear of a component, or portion of a component, of the aerosol generating assembly or article is the portion at the end closest to the downstream end of the aerosol generating assembly or article. The rear portion of the combustible heat source is the portion of the combustible heat source at the downstream end of the combustible heat source. The front portion of the aerosol forming substrate is the portion of the aerosol forming substrate at the upstream end of the aerosol forming substrate. Thus, in the example wherein the aerosol generating assembly is a double stick assembly which can be cut along the middle cross section of the assembly to generate two aerosol generating articles, the assembly comprising one combustible heat source on each end, the front faces of the combustible heat sources constitute the upstream ends of the double stick assembly. Likewise, the middle cross section constitutes the downstream end of the assembly.

As used herein with reference to the invention, the term “coating” is used to describe a layer of material that at least partially covers and is adhered to the heat source.

As used herein with reference to the invention, the term “non-combustible” is used to describe a coating that is substantially non-combustible at temperatures reached by the combustible heat source during combustion or ignition thereof.

The at least one applicator head may comprise a rolling hand. The rolling hand may apply, in the first application step, the coating formulation onto the upstream portion of the combustible heat source by coming into contact with the upstream portion of the combustible heat source.

The application of the coating formulation using a rolling hand which comes into contact with the upstream portion of the combustible heat source may be useful to reduce the amount of waste of coating formulation.

In an embodiment, the at least one rolling hand may comprise a sponge-like material. The sponge-like material may be impregnated with coating formulation. The sponge-like material may ooze out the coating formulation onto the upstream portion of the combustible heat source when the rolling hand comes into contact with the upstream portion of the combustible heat source.

The at least one applicator head may comprise at least one spray nozzle which, in the first application step, sprays the coating formulation onto the upstream portion of the combustible heat source.

Spraying the coating formulation during the first application step by means of at least one spray nozzle may allow for a quick and accurate manner of applying the coating formulation onto the upstream portion of the combustible heat source.

The at least one spray nozzle may have a diameter between about 0.1 millimetres and 1 about millimetre, preferably between about 0.2 millimetres and about 0.6 millimetres.

The at least one spray nozzle may be arranged at a distance from the upstream portion of the combustible heat source between about 0.5 millimetres and about 10 millimetres, preferably between about 1 millimetre and about 5 millimetres, even more preferably between about 1.5 millimetres and about 3 millimetres.

The at least one spray nozzle may be directed between about 45 degrees and about 90 degrees towards the longitudinal axis of the aerosol generating assembly.

This may provide a consistent coating of the upstream portion of the combustible heat source. An angle of about 90 degrees may give rise to the most consistent coating. However, values of the angle range closer to about 45 degrees may be advantageous to prevent the front face of the upstream end from being coated.

As used herein, the angles from the longitudinal axis of aerosol generating assembly always refer to the smallest angle between the longitudinal axis of the assembly and the component in question.

The least one spray nozzle may comprise a first spray nozzle and a second spray nozzle. The first spray nozzle and the second spray nozzle may be arranged on opposite sides of the aerosol generating assembly.

Employing two spray nozzles may shorten the time needed for the first application step. Since two spray nozzles are used, two areas of the upstream portion of the combustible heat source can be coated simultaneously. Likewise, when the aerosol generating assembly is rotated between a transport drum and an external roller in the manner described in more detail below, the rotation of the aerosol generating assembly relative to the at least one spray nozzle may be a combination of the rotation around its longitudinal axis and the rotation of the transport drum. Therefore, if only one stationary spray nozzle is used, the stationary spray nozzle may be insufficient to completely coat the upstream portion of the combustible heat source in the first application step. By providing two spray nozzles, the upstream portion of the combustible heat source may be completely coated even if the first spray nozzle and the second spray nozzle are stationary. Likewise, employing two spray nozzles may be beneficial to coat two upstream portions of combustible heat sources during the same first application step. The two upstream portions may belong to the same aerosol generating assembly. The two upstream portions may belong to different aerosol generating assemblies.

A front face mask may be provided between the at least one applicator head and a front face of the heat source such that the coating formulation is not applied onto the front face of the heat source during the first application step.

By ensuring that the coating formulation is not applied onto the front end face of the combustible heat source, such front face remains uncoated. This may advantageously allow sufficient air to reach the combustible heat source to facilitate ignition and sustained combustion of the combustible heat source.

A wrapper mask may be provided between the at least one applicator head and the wrapper such that the coating formulation is not applied onto the wrapper during the first application step.

This may beneficial to guarantee that the coating formulation is accurately applied only onto the upstream end of the combustible heat source. In particular, this may avoid the need for examining and correcting the alignment of the wrapper with respect to the at least one applicator head.

The wrapper mask may be arranged at between about 90 degrees and about 30 degrees from the longitudinal axis of the aerosol generating assembly.

This angle may provide a balance between effectively masking the wrapper and allowing the coating formulation to run off of the wrapper mask.

The wrapper mask may comprise at least one channel to direct coating formulation which collects on it to a specific location.

Collecting coating formulation to such specific location advantageously allows the unused coating formulation to be reused, thereby saving waste. This may also prevent the coating formulation from propagating into undesired areas of an apparatus for applying the coating formulation.

The wrapper mask may comprise a metal.

When at least one channel is provided, the wrapper mask may comprise a plurality of folds to guide coating formulation to the at least one channel. Likewise, air may be blown to help convey the coating formulation to be collected.

A first drying step may be performed after the first application step.

This may advantageously accelerate the drying process by driving off any moisture or solvent in the coating formulation when the coating is formed. In some embodiments, this is achieved by heating the coating applied to the upstream portion of the combustible heat source using hot air or infra-red radiation. In an example, the hot air used to heat the coating is also used to help convey the coating formulation to be collected.

A plurality of drying drums may be provided. The plurality of drying drums may be configured to receive the aerosol generating assembly after the first application step. The plurality of drums may be adjacent to each other in such a way that a transfer of the aerosol generating assembly between drying drums is enabled. This may enhance the drying step by adjusting the duration of the drying step. The duration of the drying step may therefore depend on the number, size, and speed of the drying drums and may be adapted depending on the characteristics of the coating formulation. The duration of the drying step may be chosen depending on the thickness and viscosity of the layer of coating formulation. The drying step may preferably be between 1 second and 15 seconds.

During the first application step, the aerosol generating assembly may be rotated between a transport drum and an external roller.

This may provide for an efficient way to perform the rotation of the aerosol generating assembly around its longitudinal axis, since this may allow for the use of equipment already used in the manufacture of other components of the aerosol generating assembly.

The transport drum and the external roller may rotate in the same direction to provide the aerosol generating assembly disposed between the transport drum and the external roller with a rotational movement around its longitudinal axis. The transport drum may comprise a plurality of grooves configured to hold the aerosol generating assembly. Suction air may be provided to hold the aerosol generating assembly in the grooves. The external roller may be configured to lift out the aerosol generating assembly from one of the plurality of grooves. The external roller may be configured to subsequently force the aerosol generating assembly to rotate around its longitudinal axis, such that the at least one applicator head applies the coating formulation onto the upstream portion of the combustible heat source. The aerosol generating assembly may roll between the transport drum and the external roller until it falls into the subsequent groove of the plurality of grooves. The aerosol generating assembly may then be moved away from the external roller.

In the embodiment wherein the at least one applicator head comprises a rolling hand, the rolling hand may be configured such that the aerosol generating assembly may be disposed between the transport drum and the rolling hand. The relative movement between the transport drum and the rolling hand may provide the aerosol generating assembly disposed between the transport drum and the rolling hand with a rotational movement around its longitudinal axis. Therefore, this embodiment may not necessarily comprise an external roller.

In an embodiment, the transport drum and the rolling hand may move in opposite directions to generate the relative movement. In an alternative embodiment, the rolling hand may be static whilst the transport drum rotates to generate the relative movement.

A second application step may be performed after the first application step, in which a coating formulation is applied from at least one applicator head onto the upstream portion of the combustible heat source while rotating the aerosol generating assembly about its longitudinal axis.

This may advantageously allow for the desired thickness of the formed coating to be built up using a plurality of layers. This may reduce the drying time for an individual layer. Reducing the drying time for an individual layer may be beneficial to reduce the overall time of manufacture of an aerosol generating article, since subsequent manufacturing steps may only start after such drying time.

In the embodiment wherein the aerosol generating assembly is rotated between a transport drum, comprising a plurality of grooves, and an external roller or a rolling hand, the distance along the perimeter of the transport drum between the subsequent grooves may be adjusted to determine how many rotations the aerosol generating assembly may do between the grooves. For example, the distance may be adjusted so the aerosol generating assembly rotates 2, 3, 4, 5 or more times. A second, third, fourth, fifth or more application steps may be performed, such that the coating formulation is applied during each of the rotations to vary the numbers of layers in the resulting coating. In alternative embodiments, the second and any subsequent application steps are performed on a different transport drum than the first application step.

The at least one applicator head of the second application step may be different from the at least one applicator of the first application step. In particular, the aerosol generating assembly may be moved from the at least one applicator head of the first application step to the at least one applicator head of the second application step using at least one transport drum.

Using different applicator heads may allow there to be a drying step between the plurality of application steps. This may improve the efficiency of the manufacturing process.

The first drying step may be performed between the first application step and the second application step.

Performing the first drying step between the first application step and the second application step may save on equipment costs and may be appropriate for building up a small number of layers where an intermediate drying step is not needed.

As set out above, the aerosol generating assemblies are used to generate (or correspond to) an aerosol generating article comprising the combustible heat source, the wrapper and the aerosol forming substrate. However, the aerosol generating article may comprise other components which may also be present in the aerosol generating assembly or that may be provided when the aerosol generating article is generated.

In an embodiment, the aerosol generating article may comprise a transfer element, or spacer element, downstream of the aerosol forming substrate. Such an element may take the form of a hollow tube that is located downstream of an aerosol forming substrate.

The transfer element may abut one or both of the aerosol forming substrate and a mouthpiece. Alternatively, the transfer element may be spaced apart from one or both of the aerosol forming substrate and the mouthpiece.

The inclusion of a transfer element may advantageously allow cooling of the aerosol generated by heat transfer from the combustible heat source to the aerosol forming substrate. The inclusion of a transfer element may also advantageously allow the overall length of the aerosol generating article to be adjusted to a desired value through an appropriate choice of the length of the transfer element.

The transfer element may have a length of between about 7 millimetres and about 50 millimetres, for example a length of between about 10 millimetres and about 45 millimetres or of between about 15 millimetres and about 30 millimetres. The transfer element may have other lengths depending upon the desired overall length of the aerosol generating article and the presence and length of other components within the aerosol generating article.

Preferably, the transfer element may comprise at least one open-ended tubular hollow body. In such embodiments, in use, air drawn into the aerosol generating article passes through the at least one open-ended tubular hollow body as it passes downstream through the aerosol generating article from the aerosol forming substrate to the distal end of the aerosol generating article.

The transfer element may comprise at least one open-ended tubular hollow body formed from one or more suitable materials that are substantially thermally stable at the temperature of the aerosol generated by the transfer of heat from the combustible heat source to the aerosol forming substrate. Suitable materials are known in the art and include, but are not limited to, paper, cardboard, plastics, such a cellulose acetate, ceramics and combinations thereof.

The aerosol generating article may comprise an aerosol-cooling element or heat exchanger downstream of the aerosol forming substrate. The aerosol-cooling element may comprise a plurality of longitudinally extending channels. Where the aerosol generating article comprises a transfer element downstream of the aerosol forming substrate, the aerosol-cooling element is preferably downstream of the transfer element.

The aerosol-cooling element may comprise a gathered sheet of material selected from the group consisting of metallic foil, polymeric material, and substantially non-porous paper or cardboard. In certain embodiments, the aerosol-cooling element may comprise a gathered sheet of material selected from the group consisting of polyethylene (PE), polypropylene (PP), polyvinylchloride (PVC), polyethylene terephthalate (PET), polylactic acid (PLA), cellulose acetate (CA) and aluminium foil.

In certain preferred embodiments, the aerosol-cooling element may comprise a gathered sheet of biodegradable polymeric material, such as polylactic acid (PLA) or a grade of Mater-Bi® (a commercially available family of starch based copolyesters).

Preferably, the aerosol generating article comprises a mouthpiece downstream of the aerosol forming substrate and positioned at the downstream end of the aerosol generating article. The mouthpiece may comprise a filter. For example, the mouthpiece may comprise a filter plug having one or more segments. Where the mouthpiece comprises a filter plug, preferably the filter plug is a single segment filter plug. The filter plug may comprise one or more segments comprising cellulose acetate, paper or other suitable known filtration materials or combinations thereof. Preferably, the filter plug comprises filtration material of low filtration efficiency.

The aerosol generating article may be substantially cylindrical in shape. The aerosol generating article may be substantially elongate. The aerosol forming substrate may be substantially cylindrical in shape. The aerosol forming substrate may be substantially elongate. The aerosol forming substrate may be located in the aerosol generating article such that the length of the aerosol forming substrate is substantially parallel to the airflow direction in the aerosol generating article.

The aerosol generating article may have any desired length. For example, the aerosol generating article may have a total length of between approximately 65 millimetres and approximately 100 millimetres. The aerosol generating article may have any desired external diameter. For example, the aerosol generating article may have an external diameter of between approximately 5 millimetres and approximately 12 millimetres.

In a disclosure of the invention, an apparatus for applying a coating to an aerosol generating assembly is provided. The apparatus may comprise a rotator for holding and rotating an aerosol generating assembly. The apparatus may comprise at least one applicator head arranged to apply a coating formulation onto an upstream portion of the aerosol generating assembly while the rotator rotates the aerosol generating assembly around its longitudinal axis.

In this disclosure, an apparatus for applying a coating to an aerosol generating assembly is provided, the apparatus comprising
a rotator for holding and rotating an aerosol generating assembly, and
at least one applicator head arranged to apply a coating formulation onto an upstream portion of the aerosol generating assembly while the rotator rotates the aerosol generating assembly around its longitudinal axis.

The apparatus of this disclosure is advantageous for the same reasons as detailed above for the method of applying a coating to the aerosol generating assembly.

As set out above, the apparatus may comprise a wrapper mask. The apparatus may comprise a front face mask. The wrapper mask and the front face mask may be configured in such a way that the coating formulation is only applied on the upstream portion of the aerosol generating assembly.

The rotator may comprise a transport drum and an external roller to rotate the aerosol generating assembly around its longitudinal axis. The rotator may comprise a transport drum and a rolling hand to rotate the aerosol generating assembly around its longitudinal axis.

The apparatus may comprise at least one drying drum configured to dry the coating formulation once applied onto the upstream portion of the aerosol generating assembly.

The apparatus may also comprise any of the components set out above when describing the methods. The advantages of such components are also set out in the description of the methods.

These and other features and advantages of the invention will become more evident in the light of the following detailed description of preferred embodiments, given only by way of illustrative and non-limiting example, in reference to the attached figures:

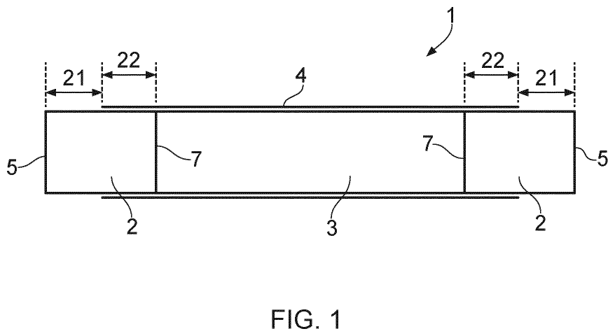

FIG. 1 shows an aerosol generating assembly.

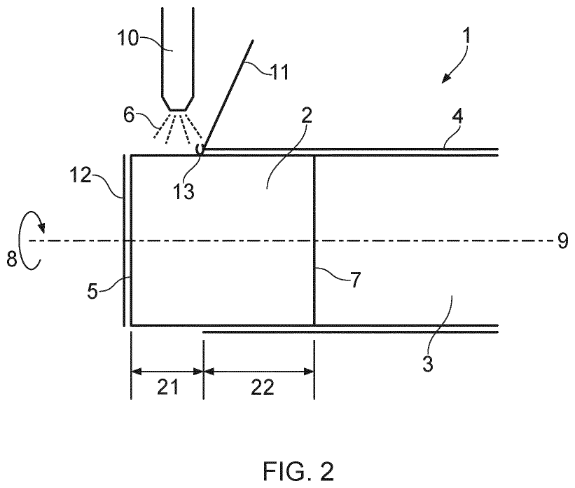

FIG. 2 illustrates an application step to apply a coating formulation to an upstream portion of a combustible heat source of the aerosol generating assembly using a spray nozzle.

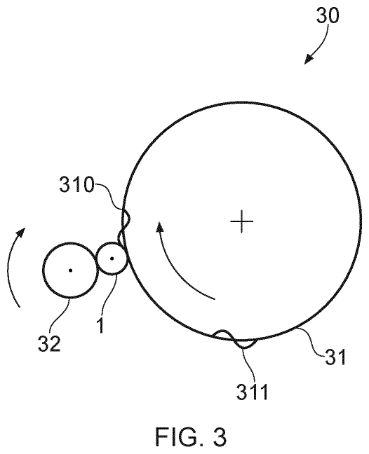

FIG. 3 depicts an external roller and a transport drum to rotate the aerosol generating assembly around its longitudinal axis during the application step of FIG. 2.

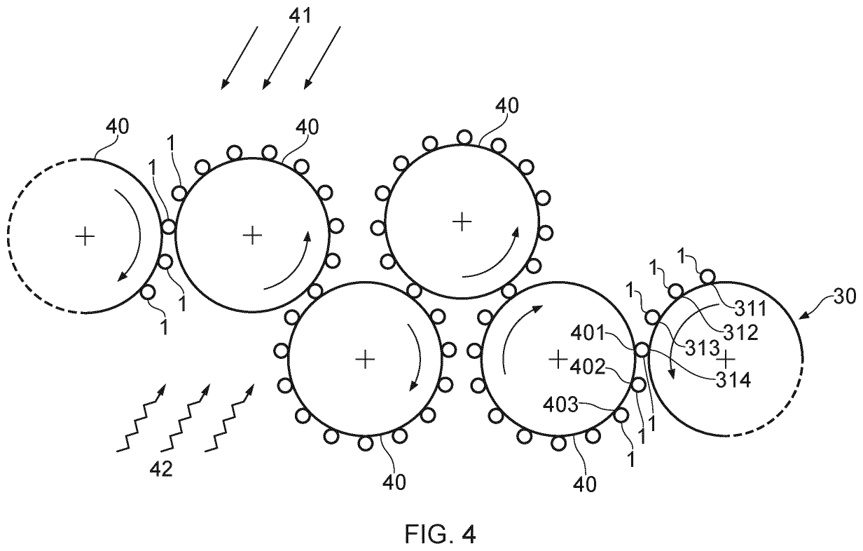

FIG. 4 represents a drying step performed after the application step in which drying drums are used.

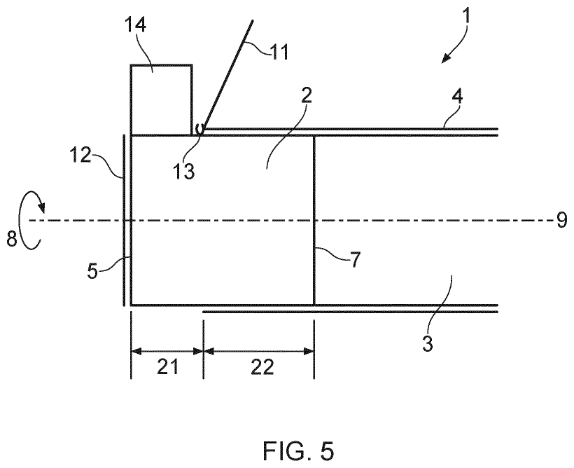

FIG. 5 illustrates an application step to apply a coating formulation to an upstream portion of a combustible heat source of the aerosol generating assembly using a rolling hand.

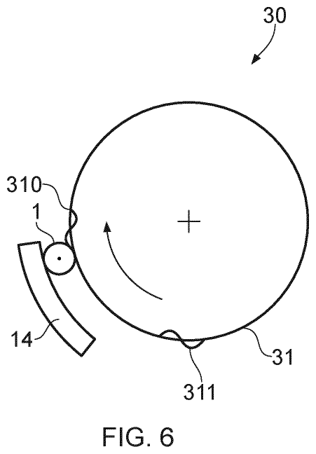

FIG. 6 depicts the rolling hand and a transport drum to rotate the aerosol generating assembly around its longitudinal axis during the application step of FIG. 5.

The aerosol generating assembly 1 of the embodiment of FIG. 1 comprises two combustible heat sources 2 and an aerosol forming substrate 3 between the combustible heat sources 2, located downstream of both combustible heat sources 2. Each combustible heat source 2 comprises a front face 5 on its upstream end and a rear face 7 on its downstream end. The front faces 5 constitute the upstream end of the aerosol generating assembly 1, whereas the middle cross section of the aerosol forming substrate 3 corresponds to the downstream end of the aerosol generating assembly 1. The aerosol forming substrate 3 and the combustible heat sources 2 are joined by a wrapper 4 disposed around the aerosol generating assembly 1 in such a way that it circumscribes aerosol forming substrate 3 and it partially circumscribes the heat sources 2. Hence, the heat sources 2 comprise an upstream portion 21 not circumscribed by the wrapper 4 and a downstream portion 22 circumscribed by the wrapper 4.

The aerosol generating assembly of FIG. 1 can give rise to two aerosol generating articles. In an embodiment, the aerosol generating assembly can be cut into two symmetrical subassemblies. The resulting subassemblies extend longitudinally from a downstream end which corresponds to the middle cross section along which the aerosol generating assembly 1 is cut and an upstream end corresponding to the front face 5.

Although not represented in FIG. 1, the aerosol generating assembly of this embodiment may also comprise other components, such as a spacer element, an aerosol cooling element, a filter or a mouthpiece. Likewise, the subassemblies generated from the aerosol generating assembly may also be provided with these components when generating the aerosol generating articles.

FIG. 2 represents a method of applying a coating to the aerosol generating assembly 1 of FIG. 1, by means of a spray nozzle 10.

An apparatus for applying the coating is provided, the apparatus comprising the spray nozzle 10 and a rotator (not represented in FIG. 2) for rotating the aerosol generating assembly 1 around its longitudinal axis 9, as indicated by arrow 8.

The spray nozzle 10 sprays a coating formulation 6 onto the upstream portion 21 of the combustible heat source 2.

In the embodiment of FIG. 2, the spray nozzle 10 is directed about 90 degrees towards the longitudinal axis 9 of the aerosol generating assembly 1, in order to provide a consistent coating.

The apparatus of FIG. 1 also comprises a wrapper mask 11, arranged between the spray nozzle 10 and the wrapper 4 such that the coating formulation 6 is not applied onto the wrapper 4 during the application step. The wrapper mask 11 is arranged at about 75 degrees from the longitudinal axis 9 of the aerosol generating assembly 1. This angle permits to recuperate and reuse the coating formulation 6 received on the wrapper mask 11, by means of a channel 13.

The apparatus of FIG. 1 also comprises a front face mask 12, arranged between the spray nozzle 10 and the front face 5 of the combustible heat source 5 such that the coating formulation 6 is not applied onto the front face 5 during the application step. In addition or alternatively to the provision of the front face mask 12, the spray nozzle 10 may be directed towards the longitudinal axis 9 with an angle between about 45 degrees and about 90 degrees.

FIG. 3 represents the rotator 30 of the apparatus of FIG. 2. The rotator 30 comprises a transport drum 31 and an external roller 32. The transport drum 31 and an the external roller 32 can rotate in clockwise direction to provide the aerosol generating assembly 1 disposed between the transport drum 31 and the external roller 32 with a rotational movement around its longitudinal axis 9. The transport drum 31 of FIG. 3 comprises a first groove 310 and a second groove 311, which are configured to hold the aerosol generating assembly 1. In an example, suction air is provided to hold the aerosol generating assembly 1 in the first groove 310 or in the second groove 311. When the external roller 32 comes into contact with the aerosol generating assembly 1 held in a groove, such as the first groove 310, the assembly 1 is lifted out of the first groove 310 and forced to rotate around its longitudinal axis 9—during such rotation, the spray nozzle 10 (not represented in FIG. 3) applies the coating formulation 6 to the upstream portion 21 of the combustible heat source 2. The aerosol generating assembly 1 rolls between the transport drum 31 and the external roller 32 until it falls into the second groove 311. Then, the aerosol generating assembly 1 is moved away from the external roller 32.

The distance along the perimeter of the transport drum 31 between the first groove 310 and the second groove 311 determines how many rotations the aerosol generating assembly 1 will do between the first groove 310 and the second groove 311. For example, the distance may be adjusted so the aerosol generating assembly 1 rotates 2, 3, 4, 5, or more times, applying at least one layer of coating formulation 6 each time. The number of layers applied may depend on the desired thickens of the coating and various properties of the coating formulation 6, for example, the viscosity of the coating formulation 6.

Once the aerosol generating assembly 1 moves away from the external roller 32, the method of this embodiment comprises a drying step performed after the application step shown in FIGS. 2 and 3. The drying step is represented in FIG. 4. FIG. 4 shows the path followed by a plurality of aerosol generating assemblies 1 after moving past the external roller 32. The aerosol generating assemblies 1 held in the second groove 311, third groove 312 and subsequent grooves 313, 314 of the transport drum 31 will be sequentially transferred to a 20.09 40 adjacent the transport drum 31 and rotating in an opposite direction to that of the transport drum 31. In this embodiment, the drying 40 drum may also comprise drying grooves 401, 402, 403, etc. to hold the aerosol generating assemblies 1 during their rotation on the drying drum 40. In this embodiment, a plurality of drying drums 40 is provided, adjacent to each other in such a way that adjacent drying drums 40 rotate in opposite directions to facilitate the transfers of the aerosol generating assemblies 1 as explained for the transfer between the transport drum 31 and the first drying drum 40. The duration of the drying step therefore depends on the number, size, and speed of the drying drums 40 and may be adapted depending on the characteristics of the coating formulation 6. The drying step of FIG. 4 is enhanced by the provision of hot air 41 and infrared radiation 42 in the area through which the aerosol generating assemblies 1 are transported by the drying drums 40.

FIG. 5 represents an embodiment of the method of applying the coating to the aerosol generating assembly 1 of FIG. 1.

Differently to the embodiment of FIG. 2, the apparatus comprises, instead of the spray nozzle 10, a rolling hand 14 which, in this embodiment, comprises a sponge-like material. The sponge-like material 14 is impregnated with coating formulation 6 such that the sponge-like material 14 oozes out the coating formulation 6 onto the upstream portion 21 of the combustible heat source 2 when the rolling hand 14 comes into contact with the upstream portion 21, as represented in FIG. 5.

FIG. 6 represents the rotator 30 of the apparatus of FIG. 5. The rotator 30 comprises a transport drum 31 similar to that of FIG. 3 and the rolling hand 14. The relative movement between the transport drum 31 and the rolling hand 14 provides the aerosol generating assembly 1 disposed between the transport drum 31 and the rolling hand 14 with a rotational movement around its longitudinal axis 9. When the rolling hand 14 comes into contact with the aerosol generating assembly 1 held in a groove, such as the first groove 310, the assembly 1 is lifted out of the first groove 310 and forced to rotate around its longitudinal axis 9—during such rotation, the sponge-like material of the rolling hand 14 applies the coating formulation 6 to the upstream portion 21 of the combustible heat source 2 by oozing out the coating formulation 6 onto the upstream portion 21. The aerosol generating assembly 1 rolls between the transport drum 31 and the rolling hand 14 until it falls into the second groove 311. Then, the aerosol generating assembly 1 is moved away from the rolling hand 14.

Except in the features set out above, the embodiment of FIGS. 5 and 6 is similar to that of FIGS. 2 and 3. The common features are not described again here for the sake of conciseness. Likewise, in the embodiment of FIGS. 5 and 6, once the aerosol generating assembly 1 moves away from the rolling hand 14, the method of this embodiment comprises a drying step performed as illustrated in FIG. 4 and described above.

1-14. (canceled)

15. A method of applying a coating to an aerosol generating assembly, the method comprising the steps of:
providing an aerosol generating assembly, the aerosol generating assembly comprising a combustible heat source, an aerosol forming substrate and a wrapper joining the combustible heat source and the aerosol forming substrate, the combustible heat source having a downstream portion circumscribed by the wrapper and an upstream portion not circumscribed by the wrapper; and
applying, in a first application step, a coating formulation from at least one applicator head onto the upstream portion of the combustible heat source while rotating the aerosol generating assembly about its longitudinal axis.

16. A method according to claim 15, wherein the at least one applicator head comprises at least one rolling hand which, in the first application step, applies the coating formulation onto the upstream portion of the combustible heat source by coming into contact with the upstream portion of the combustible heat source.

17. A method according to claim 15, wherein the at least one applicator head comprises at least one spray nozzle which, in the first application step, sprays the coating formulation onto the upstream portion of the combustible heat source.

18. A method according to claim 15, further comprising providing a front face mask between the at least one applicator head and a front face of the combustible heat source such that the coating formulation is not applied onto the front face during the first application step.

19. A method according to claim 15, further comprising providing a wrapper mask between the at least one applicator head and the wrapper such that the coating formulation is not applied onto the wrapper during the first application step.

20. A method according to claim 19, wherein the wrapper mask is arranged at between about 30 degrees and about 90 degrees from the longitudinal axis of the aerosol generating assembly.

21. A method according to claim 19, wherein the wrapper mask comprises at least one channel to direct coating formulation which collects on it to a specific location.

22. A method according to claim 15, wherein during the first application step, the aerosol generating assembly is rotated between a transport drum and an external roller.

23. A method according to claim 15, further comprising a first drying step performed after the first application step.

24. A method according to claim 15, further comprising a second application step after the first application step in which a coating formulation is applied from at least one applicator head onto the upstream portion of the combustible heat source while rotating the aerosol generating assembly about its longitudinal axis.

25. A method according to claims 23, wherein the first drying step occurs between the first application step and the second application step.

26. An apparatus for applying a coating to an aerosol generating assembly, the apparatus comprising
a rotator for holding and rotating an aerosol generating assembly,
at least one applicator head arranged to apply a coating formulation onto an upstream portion of the aerosol generating assembly while the rotator rotates the aerosol generating assembly around its longitudinal axis,
a wrapper mask and a front face mask configured in such a way that the coating formulation is only applied onto the upstream portion of the aerosol generating assembly, and
at least one drying drum configured to dry the coating formulation once applied onto the upstream portion of the aerosol generating assembly.

27. The apparatus according to claim 26, wherein the rotator further comprises a transport drum and an external roller to rotate the aerosol generating assembly around its longitudinal axis.
